(19) United States
(12) Patent Application Publication
(10) Pub. No.: US 2009/0195474 A1
(43) Pub. Date: Aug. 6, 2009

(54) DUAL-FEED PLANAR ANTENNA

(75) Inventors: Shao-Lun CHIEN, Taipei (TW); Chun-Chih CHEN, Taipei (TW); Chien-Yi WU, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: PEGATRON CORPORATION, Taipei (TW)

(21) Appl. No.: 12/357,604

(22) Filed: Jan. 22, 2009

(30) Foreign Application Priority Data
Feb. 4, 2008 (TW) 097104168

(51) Int. Cl. H01Q 1/36; H01Q 1/48

(52) U.S. Cl. 343/846; 343/700 MS

(57) ABSTRACT

The invention provides a dual-feed planar antenna including a first resonant portion, a second resonant portion, and a grounding portion. The first resonant portion provides a first radiation path and includes a first feed-in portion and a grounding end receiving a grounding level. The first feed-in portion receives a first antenna signal to transmit the first antenna signal to the first radiation path. The second resonant portion provides a second radiation path and a third radiation path and includes a second feed-in portion respectively receiving a second antenna signal and a third antenna signal to correspondingly transmit the second antenna signal and the third antenna signal to the second radiation path and the third radiation path. The grounding portion receives the grounding level and is disposed between the first and second resonant portions. The dual-feed planar antenna covers the communication bands for GSM850, GSM900, GPS, DCS, PCS, and UMTS.

### CROSS-REFERENCE TO RELATED APPLICATIONS

This non-provisional application claims priority under 35 U.S.C. §119(a) on Patent Application No. 097104168 filed in Taiwan on Feb. 4, 2008, the entire contents of which are hereby incorporated by reference.

### BACKGROUND OF THE INVENTION

1. Field of the Invention

The invention relates to a multiband planar antenna and, more particularly, to a dual-feed planar antenna.

2. Description of the Prior Art

Along with the development of the wireless communication, the wireless communication is widely used, and more communication channels are needed. One solution is that more and more frequencies originally not used are used. To effectively use the usable communication bands, since the communication bands that are newly used are often adjacent to the originally used communication bands, communication isolation is needed. In the design of products, the wireless communication products are required to have a multiband communication function, and therefore, the wireless communication products need to have antennas that can operate in a plurality of communication bands. The antennas having a single feed-in point do not need the communication isolation because the wireless communication products only need to process signals of one communication band (even the up or down link channel) at the same time. As for the dual-feed antennas or the multi-feed antennas, the antennas connected to the feed-in cables often communicate at the same time, and therefore, interference may occur between them.

To solve the above problem, the conventional solution is that the antennas are isolated with an interval that is a quarter to a half of the maximum wavelength of the communication band used by the antennas to assure that the interference is reduced to be acceptable, which increases the overall volume of the antennas. The wireless communication products become small, and the space for installing the antennas greatly reduces. Therefore, a new dual-feed planar antenna that still can have sufficient radiation efficiency without making the internal antennas have an interval of a half of the maximum wavelength is needed to solve the above problem.

### SUMMARY OF THE INVENTION

One objective of the invention is to provide a dual-feed planar antenna.

The dual-feed planar antenna of the invention includes a first resonant portion, a second resonant portion and a grounding portion. The first resonant portion provides a first radiation path and includes a first feed-in portion and a grounding end receiving a grounding level. After the first feed-in portion receives a first antenna signal, it transmits the first antenna signal to the first radiation path. The second resonant portion provides a second radiation path and a third radiation path and includes a second feed-in portion. After the second feed-in portion receives a second antenna signal and a third antenna signal, respectively, it correspondingly transmits the second antenna signal and the third antenna signal to the second radiation path and the third radiation path. The second feed-in portion is located between the second radiation path and the third radiation path. The grounding portion receives the grounding level and is disposed between the first resonant portion and the second resonant portion to isolate the first resonant portion and the second resonant portion.

In one embodiment, the first resonant portion has a protrudent portion, and the first feed-in portion and the grounding end are located at the protrudent portion. The grounding end can be connected to the grounding portion via the protrudent portion to receive the grounding level. The protrudent portion is included in one end of the first resonant portion away from the second resonant portion to isolate the first and second resonant portions effectively for preventing interference.

In one embodiment, the first resonant portion, the second resonant portion and the grounding portion are formed on a flat plate.

Each of the first resonant portion and the second resonant portion of the dual-feed planar antenna of the embodiment of the invention provides a radiation path, and each radiation path has an operating band. The range covered by the operating band is not limited to a single communication band. The operating band may cover a plurality of communication bands that exist at present, and it even may cover a plurality of discrete communication bands such as the GSM850 communication band (824 MHz to 894 MHz), the GSM900 communication band (880 MHz to 960 MHz), the GPS communication band (1575.42 MHz), the DCS communication band (1710 MHz˜1880 MHz), the PCS communication band (1850 MHz˜1990 MHz), the UMTS communication band (1920 MHz˜2170 MHz) and other communication band.

In one embodiment, the operating band provided by the first radiation path of the first resonant portion includes the GPS communication band. The operating band provided by the second radiation path of the second resonant portion includes the GSM850 communication band and the GSM900 communication band. The operating band provided by the third radiation path of the second resonant portion includes the DCS communication band, the PCS communication band and the UMTS communication band.

To sum up, the two resonant portions of the dual-feed planar antenna of the invention are isolated to have permissible isolation without making the interval between the two resonant portions be a half of the maximum wavelength used by the two resonant portions, and the overall radiation efficiency of the dual-feed planar antenna can be maintained.

These and other features, aspects, and advantages of the present invention will become better understood with regard to the following description, appended claims, and accompanying drawings.

### BRIEF DESCRIPTION OF THE APPENDED DRAWINGS

FIG. 1 is a schematic diagram showing a dual-feed planar antenna according to a preferred embodiment of the invention;

FIG. 2A is a schematic diagram showing the voltage standing wave ratio (VSWR) of the first resonant portion of the dual-feed planar antenna;

FIG. 2B is a schematic diagram showing the VSWR of the second resonant portion of the dual-feed planar antenna; and

FIG. 3 is a schematic diagram showing the isolation between the first resonant portion and the second resonant portion.

### DETAILED DESCRIPTION OF THE INVENTION

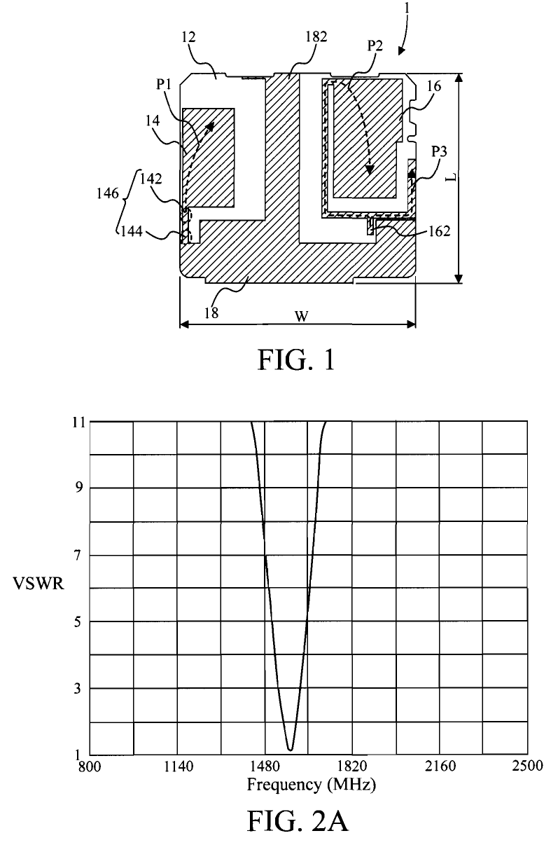

As shown in FIG. 1, FIG. 1 is a schematic diagram showing a dual-feed planar antenna 1 according to a preferred embodiment of the invention. The dual-feed planar antenna 1 of the embodiment of the invention includes a flat plate 12 that is a rectangular flat plate having a width W (about 42 mm) and a length L (about 37 mm). The dual-feed planar antenna 1 includes a first resonant portion 14, a second resonant portion 16 and a grounding portion 18 formed on the flat plate 12, and the first resonant portion 14, the second resonant portion 16 and the grounding portion 18 are shown in FIG. 1 with oblique shade lines. The first resonant portion 14 includes a first feed-in portion 142 and a grounding end 144 (the position of which is denoted with a broken line) and provides a first radiation path P1 (denoted by a broken arrow).The first feed-in portion 142 and the grounding end 144 are located at one protrudent portion 146 of the first resonant portion 14. The grounding end 144 is connected to the grounding portion 18 via the protrudent portion 146 to receive a grounding level. The first feed-in portion 142 can transmit or receive a first antenna signal, and it can transmit the first antenna signal to or receive the first antenna signal from the first radiation path P1.

The second resonant portion 16 also includes a second feed-in portion 162 and provides a second radiation path P2 and a third radiation path P3 (denoted by broken arrows). The second feed-in portion 162 is located between the second radiation path P2 and the third radiation path P3 and can transmit or receive a second antenna signal and a third antenna signal to allow the second antenna signal to be transmitted to or receive from the second radiation path P2 and allow the third antenna signal to be transmitted to or receive from the third radiation path P3. The grounding portion 18 includes an isolation portion 182 located between the first resonant portion 14 and the second resonant portion 16. The first feed-in portion 142 of the first resonant portion 14 and the second feed-in portion 162 of the second resonant portion 16 are connected to a feed-in wire (such as a coaxial cable), respectively, to form a dual-feed condition. The dual-feed planar antenna 1 of the embodiment of the invention is formed by a printed circuit board, and the base plate of the printed circuit board is the flat plate 12. The copper foil of the printed circuit board is used to form the first resonant portion 14, the second resonant portion 16 and the grounding portion 18.

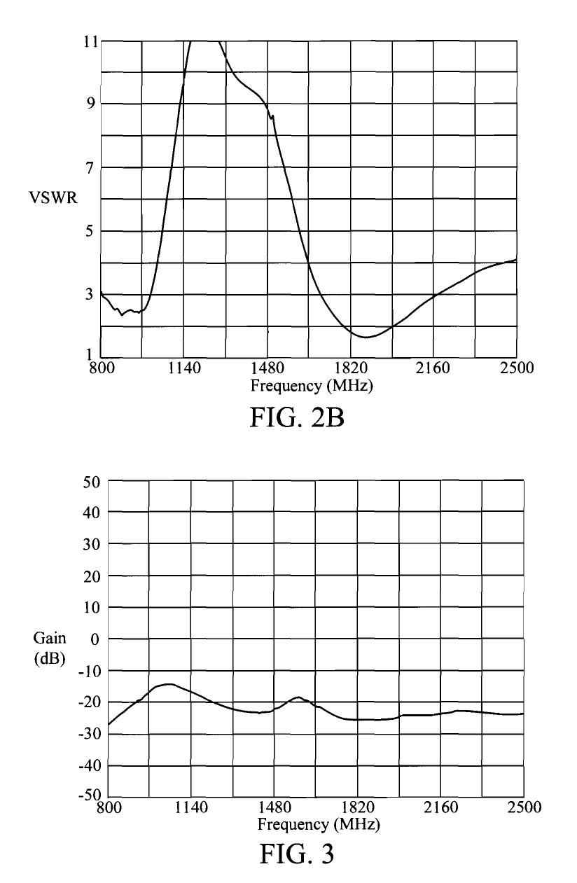

As shown in FIG. 2A and FIG. 2B, FIG. 2A is a schematic diagram showing the voltage standing wave ratio (VSWR) of the first resonant portion 14 of the dual-feed planar antenna 1, and FIG. 2B is a schematic diagram showing the VSWR of the second resonant portion 16 of the dual-feed planar antenna 1. According to the preferred embodiment of the invention, the first radiation path P1 provided by the first resonant portion 14 has an operating band covering the GPS communication band as shown in FIG. 2A. The second radiation path P2 provided by the second resonant portion 16 has another operating band covering the GSM850 communication band and the GSM900 communication band. The third radiation path P3 provided by the second resonant portion 16 has another operating band covering the DCS communication band, the PCS communication band and the UMTS communication as shown in FIG. 2B. Therefore, as shown in FIG. 2A and FIG. 2B, the dual-feed planar antenna 1 of the embodiment of the invention still can have a good antenna characteristic with a small area (42 mm×37 mm). The operating band of the invention is not limited to a signal communication band or a continuous band, and it may also covers a plurality of communication bands that exist at present or be a group consisting of a plurality of discrete communication bands.

Compared with the conventional technology, the dual-feed planar antenna 1 of the embodiment of the invention does not utilize not only the space for isolating (that is, the interval that is more than a half of the maximum wavelength of the communication band is used to isolate) but also the opposite antenna polarized directions for reducing the interference. In the invention, the isolation portion 182 of the grounding portion 18 is disposed between the resonant portions 14 and 16 to isolate or reduce the interference between the two resonant portions 14 and 16. The protrudent portion 146 is included in one end of the first resonant portion 14 away from the second resonant portion 16, which is helpful to the reduction of the interference between the two resonant portions 14 and 16. FIG. 3 is a schematic diagram showing the isolation between the first resonant portion 14 and the second resonant portion 16. As shown in FIG. 3, in the range 800 MHz to 2500 MHz, the isolation between the first resonant portion 14 and the second resonant portion 16 is less than −15 dB at each operating band. Therefore, the first resonant portion 14 and the second resonant portion 16 of the dual-feed planar antenna 1 of the embodiment of the invention have good isolation.

As shown in FIG. 1, FIG. 1 shows the content therein according to a scale. The shortest distance between the first resonant portion 14 and the second resonant portion 16 is about 16 mm that is much smaller than a half of the conventional maximum wavelength (for example, the maximum wavelength used by the GSM850 communication band is 364 mm, and a half of the wavelength is 182 mm). The width of the isolation portion 182 disposed between the first resonant portion 14 and the second resonant portion 16 is only about 6 mm. The whole dual-feed planar antenna 1 is disposed in an area of 42 mm×37 mm, which can not be obtained by the conventional technology. The resonant portions 14 and 16 of the dual-feed planar antenna 1 of the embodiment of the invention still can have good isolation and a good antenna radiation characteristic.

As shown in Table 1, Table 1 lists the three dimensional (3D) radiation efficiency of the dual-feed planar antenna 1 of the embodiment of the invention in the GSM850 communication band and the GSM900 communication band. As shown in Table 1, the 3D radiation efficiency of the dual-feed planar antenna 1 in the range is above 50%.

TABLE 1
the 3D radiation efficiency in the GSM850 and GSM900
communication bands

| frequency (MHz) | 3D radiation efficiency (%) |
|---|---|
| 824 | 54.7148 |
| 836 | 54.7374 |
| 849 | 53.4663 |
| 869 | 53.9164 |
| 880 | 55.8545 |
| 894 | 58.0029 |
| 900 | 59.6085 |
| 915 | 60.0829 |
| 925 | 59.0714 |
| 940 | 56.3567 |
| 960 | 55.6555 |

As shown in Table 2, Table 2 lists the 3D radiation efficiency of the dual-feed planar antenna 1 of the embodiment of the invention in the DCS communication band, the PCS communication band and the UMTS communication band. As shown in Table 2, the 3D radiation efficiency of the dual-feed planar antenna 1 still is about 30% in the range and is above about 50% in the middle of the range.

TABLE 2
the 3D radiation efficiency in the DCS, PCS and UMTS
communication bands

| frequency (MHz) | 3D radiation efficiency (%) |
|---|---|
| 1710 | 29.6115 |
| 1750 | 36.7808 |
| 1785 | 35.8026 |
| 1805 | 35.7195 |
| 1840 | 42.6564 |
| 1850 | 41.0482 |
| 1880 | 45.0093 |
| 1910 | 47.9288 |
| 1920 | 49.1687 |
| 1930 | 51.4886 |
| 1950 | 50.9045 |
| 1960 | 50.1144 |
| 1980 | 45.5206 |
| 1990 | 36.3269 |
| 2110 | 34.2035 |
| 2140 | 31.7854 |
| 2170 | 30.1805 |

As shown in Table 3, Table 3 lists the 3D radiation efficiency of the dual-feed planar antenna 1 of the embodiment of the invention in the GPS communication band. As shown in Table 3, the 3D radiation efficiency of the dual-feed planar antenna 1 is about 50% in the range.

TABLE 3
the 3D radiation efficiency in the GPS communication band

| frequency (MHz) | 3D radiation efficiency (%) |
|---|---|
| 1570 | 48.6496 |
| 1575 | 48.2488 |
| 1580 | 49.3428 |

To sum up, in the invention, the two resonant portions of the dual-feed planar antenna can be effectively isolated and obtain the permissible isolation without making the interval between the two resonant portions be a half of the maximum wavelength used by the two resonant portions, and the overall 3D radiation efficiency of the dual-feed planar antenna still can be maintained. In the preferred embodiment, the dual-feed planar antenna 1 can operate in the GSM850 communication band, the GSM900 communication band, the GPS communication band, the DCS communication band, the PCS communication band and the UMTS communication band and can be provided on a flat plate 12 of 42 mm×37 mm, and the two resonant portions 14 and 16 still have good isolation (−15 to −20 dB) and have good 3D radiation efficiency (30 to 50%).

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A dual-feed planar antenna comprising:
a first resonant portion providing a first radiation path and including a first feed-in portion and a grounding end receiving a grounding level, wherein after the first feed-in portion receives a first antenna signal, the first feed-in portion transmits the first antenna signal to the first radiation path;
a second resonant portion providing a second radiation path and a third radiation path and including a second feed-in portion for respectively receiving a second antenna signal and a third antenna signal to correspondingly transmit the second antenna signal and the third antenna signal to the second radiation path and the third radiation path; and
a grounding portion receiving the grounding level and disposed between the first resonant portion and the second resonant portion.

2. The dual-feed planar antenna according to claim 1, wherein the first feed-in portion and the grounding end are located at a protrudent portion of the first resonant portion.

3. The dual-feed planar antenna according to claim 2, wherein the protrudent portion is included in one end of the first resonant portion away from the second resonant portion.

4. The dual-feed planar antenna according to claim 2, wherein the grounding end is connected to the grounding portion via the protrudent portion to receive the grounding level.

5. The dual-feed planar antenna according to claim 1, wherein the second feed-in portion is located between the second radiation path and the third radiation path.

6. The dual-feed planar antenna according to claim 1 further comprising a flat plate on which the first resonant portion, the second resonant portion and the grounding portion are formed.

7. The dual-feed planar antenna according to claim 1, wherein the second resonant portion has an operating band selected from a group consisting of the GSM850 communication band, the GSM900 communication band, the DCS communication band, the PCS communication band and the UMTS communication band.

8. The dual-feed planar antenna according to claim 1, wherein the first radiation path has a first operating band including the GPS communication band.

9. The dual-feed planar antenna according to claim 1, wherein the second radiation path has a second operating band including the GSM850 communication band and the GSM900 communication band.

10. The dual-feed planar antenna according to claim 1, wherein the third radiation path has a third operating band including the DCS communication band, the PCS communication band and the UMTS communication band.
